(19) United States
(12) Patent Application Publication
(10) Pub. No.: US 2026/0203634 A1
(43) Pub. Date: Jul. 16, 2026

(54) Quantum-Assisted Preconditioning of Optimization Problems

(71) Applicant: Rigetti & Co, LLC, Berkeley, CA (US)

(72) Inventors: Maxime Dupont, Berkeley, CA (US); Bhuvanesh Sundar, Ithaca, NY (US)

(73) Assignee: Rigetti & Co, LLC, Berkeley, CA (US)

(21) Appl. No.: 19/411,025

(22) Filed: Dec. 5, 2025

Related U.S. Application Data
(63) Continuation of application No. PCT/US2024/033445, filed on Jun. 11, 2024.
(60) Provisional application No. 63/507,659, filed on Jun. 12, 2023.
(60) Provisional application No. 63/632,079, filed on Apr. 10, 2024.

(51) Int. Cl. G06N 10/60

(52) U.S. Cl. CPC G06N 10/60

(57) ABSTRACT

In a general aspect, quantum-assisted preconditioning of optimization problems is described. In some cases, preconditioning an initial optimization problem includes causing a quantum computing resource to execute a quantum-based algorithm corresponding to the initial optimization problem. Quantum results are obtained based on the execution of the quantum-based algorithm; the quantum results are indicative of one or more solutions to the initial optimization problem as determined by the quantum-based algorithm. Based on the quantum results, a preconditioned optimization problem is generated; the preconditioned optimization problem includes elements indicative of correlations between variables associated with the initial optimization problem. Preconditioned problem results are obtained based on an execution of a solver on the preconditioned optimization problem. The preconditioned problem results may be returned as the output of the initial optimization problem.

### CROSS-REFERENCE TO RELATED APPLICATIONS

This application claims priority to U.S. Provisional Patent Application No. 63/507,659, filed Jun. 12, 2023, entitled “Hybrid Quantum Systems and Methods for Quantum Assisted Execution of Relax-and-Round Algorithms;” and U.S. Provisional Patent Application No. 63/632,079, filed Apr. 10, 2024, entitled “Hybrid Quantum Systems and Methods for Quantum Assisted Execution of Relax-and-Round Algorithms.” The above-referenced priority documents are incorporated herein by reference.

### GOVERNMENT SUPPORT

This invention was made with Government support under agreement No. HR00112090058, awarded by DARPA. The Government has certain rights in the invention.

### TECHNICAL FIELD

The following description relates generally to quantum-assisted preconditioning of optimization problems.

### BACKGROUND

Quantum computers can perform computational tasks by storing and processing information within quantum states of quantum systems. For example, qubits (i.e., quantum bits) can be stored in, and represented by, an effective two-level sub-manifold of a quantum coherent physical system. A variety of physical systems have been proposed for quantum computing applications. Examples include superconducting circuits, trapped ions, spin systems, and others.

### BRIEF DESCRIPTION OF THE DRAWINGS

FIG. 1 is a block diagram showing aspects of an example computing environment.

FIG. 2 is a flowchart showing aspects of an example process.

FIG. 3 is a flowchart showing aspects of an example process.

FIG. 4 is a schematic diagram showing an example process to determine a preconditioned problem represented by a correlation matrix Z based on candidate solutions returned from running an initial algorithm to solve an initial problem.

FIGS. 5A-5C are ladder diagrams showing aspects of an example process.

FIG. 6 is a flowchart showing aspects of an example process.

FIGS. 7A-7C are ladder diagrams showing aspects of an example process.

### DETAILED DESCRIPTION

In some aspects of what is described here, an optimization problem is preconditioned using a quantum-assisted method. The quantum-assisted preconditioning can transform an initial optimization problem to a preconditioned optimization problem, by solving which using a classical or a quantum solver can produce one or more solutions to the initial optimization problem. In certain instances, the quantum-assisted preconditioning method includes an execution of a quantum-based algorithm; and generated the preconditioned optimization problem based on quantum results from the execution of the quantum-based algorithm. Elements of the preconditioned optimization problem are indicative of correlations between variables associated with the initial optimization problem.

In some aspects, the methods and techniques presented here include an efficient algorithm that determines candidate solutions of an initial optimization problem by applying a quantum-based algorithms; builds a preconditioned optimization problem based the candidate solutions; and seeks to improve the quality of solution to the initial optimization problem by solving the preconditioned optimization problem. In some instances, when applied to candidate solutions produced by quantum-based optimization algorithms such as the QAOA, by virtue of being completely robust to certain types of quantum noise, and by being able to leverage error mitigation techniques to suppress other types of noise, the methods and techniques presented here can enable practitioners to mitigate the reduced quality of solutions produced by the noisy quantum computer.

In some implementations, the methods and techniques disclosed here can provide technical advantages. The methods and techniques presented here may have the benefit of generating results that are potentially closer to the optimal solution of the initial optimization problem. In some instances, a quantum computing resource of a hybrid computer system is configured to perform functions such as to execute the quantum-based algorithm; a classical computing resource of the computer system can be configured to find the most relevant features (e.g., determine a correlation matrix) of the initial optimization problem based on output of the quantum-based algorithm, and to build the preconditioned optimization problem based on the most relevant features. In some instances, the quantum computing resource and the classical computing resource of the computer system may be configured to perform other operations. The methods and techniques presented here can be used to solve combinatorial optimization problems in wide-ranging applications such as basic science, machine learning, operations research, finance, scheduling, and other logistical operations. The methods and techniques presented here can provide improved efficiency for obtaining solutions and improved quality of solutions. In some cases, a combination of these and potentially other advantages and improvements may be obtained.

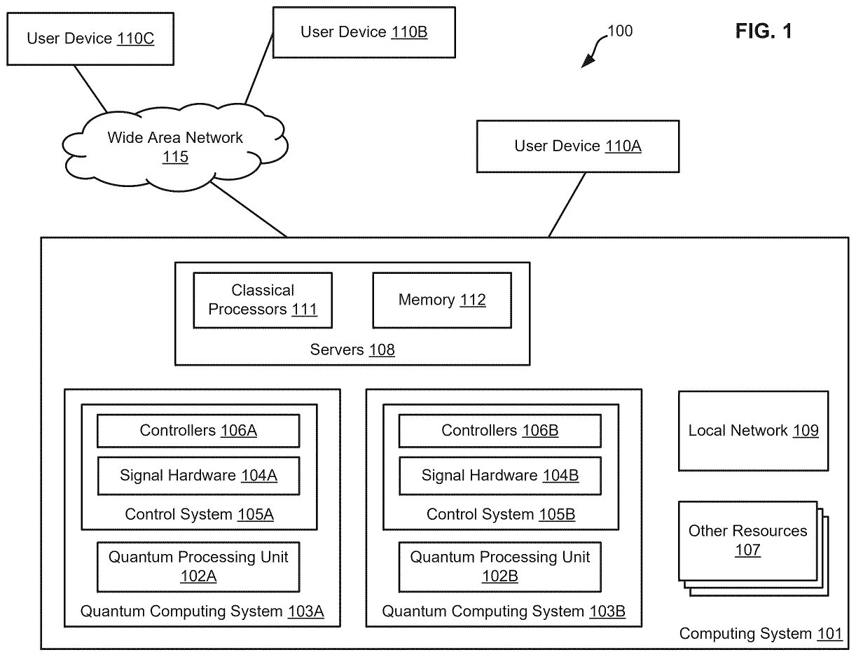

FIG. 1 is a block diagram of an example computing environment 100, according to an example embodiment. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109, or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner. For simplicity of discussion, the term “program,” as used herein, may refer to a quantum-assisted semidefinite programming algorithm, which includes a quantum-based algorithm that executes on quantum computer systems, a construction of a new problem based on outputs of the quantum-based algorithm on classical computer systems, a semidefinite programming method that executes on classical computer systems.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B, and the other resources 107 may communicate with each other through the local network 109. In some implementations, the local network 109 operates as a communication channel that provides one or more low-latency communication pathways from the server 108 to the quantum computing systems 103A, 103B (or to one or more of the elements of the quantum computing systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remote from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B, and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115, and possibly other channels. In some implementations, the servers 108 may include a host server, an application server, a virtual server, or a combination of these and other types of servers. The servers 108 may include additional or different features and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media, and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution. For example, the servers 108 may send programs to the quantum computing system 103A, the quantum computing system 103B, or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv:1608.03355v2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may be expressed in another form or format. In some cases, a program may utilize Quil-T, described in the publication “Gain deeper control of Rigetti quantum processing units with Quil-T,” available at https://medium.com/rigetti/gain-deeper-control-of-rigetti-quantum-processors-with-quil-t-ea8945061e5b dated Dec. 10, 2020, which is hereby incorporated by reference in the present disclosure.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

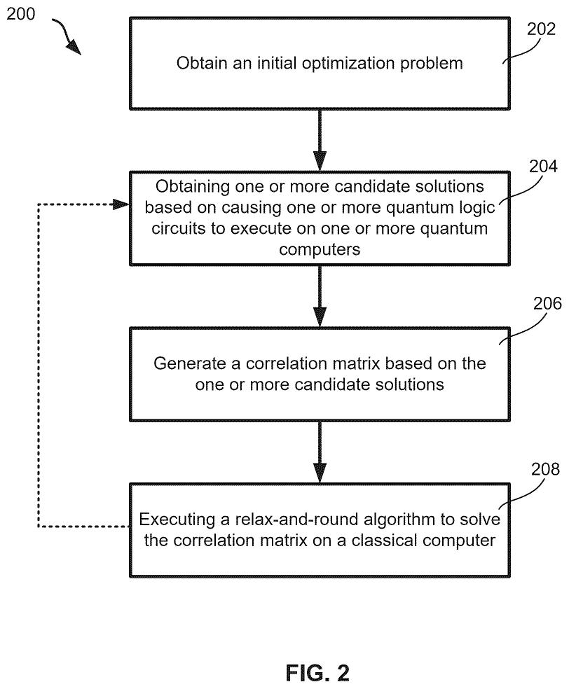

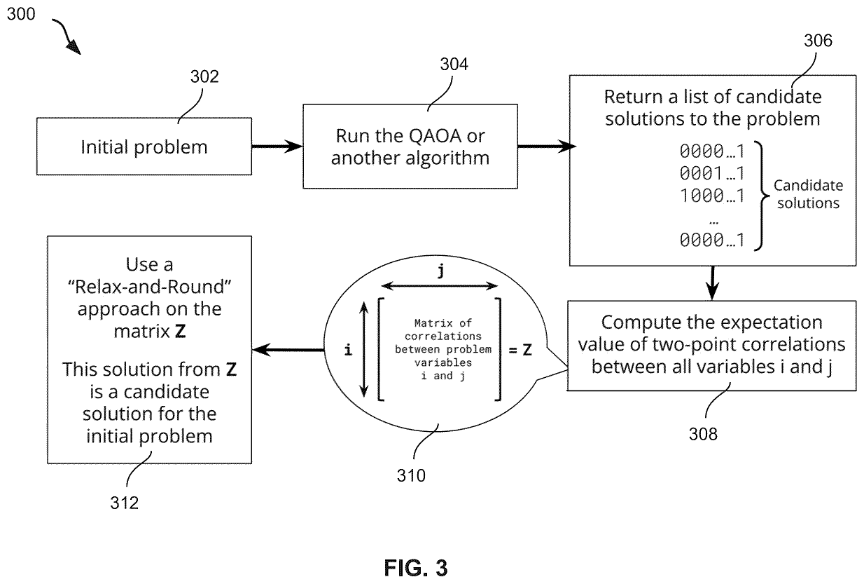

In some implementations, the servers 108 generate a schedule for executing programs (such as the programs shown in FIGS. 2, 3), allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing system 101 operates as a hybrid computer environment. For example, quantum programs can be formatted as hybrid classical/quantum programs that include instructions for execution by one or more quantum computing resources (e.g., the quantum-based algorithms) and instructions for execution by one or more classical resources (e.g., the semidefinite programming). The servers 108 can allocate quantum and classical computing resources in the hybrid computer environment, and delegate programs to the allocated computing resources for execution. The quantum computing resources in the hybrid environment may include, for example, one or more quantum processing units (QPUs), one or more quantum virtual machines (QVMs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in, and represented by, an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting codes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

In some instances, all or part of the quantum processing unit 102A functions as a quantum processing unit, a quantum memory, or another type of subsystem. In some examples, the quantum processing unit 102A includes a superconducting quantum circuit system. The superconducting quantum circuit may include data qubit devices, stabilizer qubit devices, coupler devices, readout devices, and possibly other devices that are used to store and process quantum information. In some cases, multiple data qubit devices are operatively coupled to a single stabilizer check qubit device through respective coupler devices. In some implementations, the quantum processing unit 102A is implemented utilizing aspects designed or generated from the components and processes shown in FIGS. 2-4, or in another manner. In certain examples, the qubit devices and the coupler devices are implemented as superconducting quantum circuit devices that include Josephson junctions, for example, in Superconducting QUantum Interference Device (SQUID) loops or other arrangements, and are controlled by radio-frequency signals, microwave signals, and bias signals delivered to the quantum processing unit 102A.

In some instances, the quantum processing modules can include a superconducting quantum circuit that includes one or more quantum circuit devices. For instance, a superconducting quantum circuit may include qubit devices, readout resonator devices, Josephson junctions, or other quantum circuit devices. In some implementations, quantum circuit devices in a quantum processing unit can be collectively operated to define a single logical qubit. A logical qubit comprises a quantum register, for instance multiple physical qubits or qudits, and associated circuitry, that supports physical operations which can be used to detect or correct errors associated with logical states in a quantum algorithm. Physical operations supported by the quantum register associated with a logical qubit may include single-qubit or multi-qubit quantum logic gates and readout mechanisms. Error detection or correction mechanisms associated with a logical qubit may be based on quantum error correction schemes such as the surface code, color code, Bacon-Shor codes, low-density parity check codes (LDPC), some combination of these, or others.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems, or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computing system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations, or other types of operations. As an example, the signal hardware 104A may include arbitrary waveform generators (AWGs) that generate electromagnetic waveforms (e.g., microwave or radio-frequency) or laser systems that generate optical waveforms. The waveforms or other types of signals generated by the signal hardware 104A can be delivered to devices in the quantum processing unit 102A to operate qubit devices, readout devices, bias devices, coupler devices, or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radiofrequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers, and other types of components. In some instances, the signal delivery hardware performs preprocessing, signal conditioning, or other operations to the control signals to be delivered to the quantum processing unit 102A. In some instances, signal delivery hardware performs preprocessing, signal conditioning, or other operations on readout signals received from the quantum processing unit 102A.

The example controllers 106A communicate with the signal hardware 104A to control the operation of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in one or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bit string representing qubit state measurements for a single execution of the quantum program, and a collection of bit strings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computing system 103B and its components (e.g., the quantum processing unit 102B, the signal hardware 104B, and controllers 106B) can be implemented as described above with respect to the quantum computing system 103A; in some cases, the quantum computing system 103B and its components may be implemented or may operate in another manner.

In some implementations, the quantum computing systems 103A, 103B are disparate systems that provide distinct modalities of quantum computation. For example, the computer system 101 may include both an adiabatic quantum computing system and a gate-based quantum computer system. As another example, the computer system 101 may include a superconducting circuit-based quantum computing system and an ion trap-based quantum computer system. In such cases, the computer system 101 may utilize each quantum computing system according to the type of quantum program that is being executed, according to availability or capacity, or based on other considerations.

For example, a classical computing resource (e.g., the user device, 110, the server 108, the control system 105, etc.) may execute a relax-and-round algorithm or other semidefinite programming method wherein the classical computing resource requests the quantum computing resource (e.g., the quantum processing unit 102) to perform a quantum-based algorithm in operations of the example process 200, 300, 400, 500, 510, 520, 600, 700, 710, 720 in FIGS. 2-7C. Such requests and results may be communicated via a shared memory between the systems.

FIG. 2 is a flowchart showing aspects of an example process 200. In some instances, the example process 200 can be performed by the computer system 100 shown in FIG. 1, or another type of computer system for determining a solution to an optimization problem or another type of problem. In some implementations, the example process 200 describes a quantum-assisted preconditioning of an initial optimization problem to generate a preconditioned optimization problem; and solving the preconditioned optimization problem using a relax-and-round algorithm. In other words, the example process 200 is a quantum-assisted relax-and-round algorithm.

At 202, an initial problem to be solved is obtained by the computer system. The initial problem may be an optimization problem, which may include quadratic unconstrained binary optimization (QUBO) problems and may have applications in finance optimization, routing, scheduling, economics, machine learning, science, and the like. In some instances, the initial problem may be other types of optimization problems as well as machine learning techniques, quantum machine learning techniques, variational quantum algorithms, workflows, or other problems. In some instances, the initial problem may be encoded in an initial matrix, W.

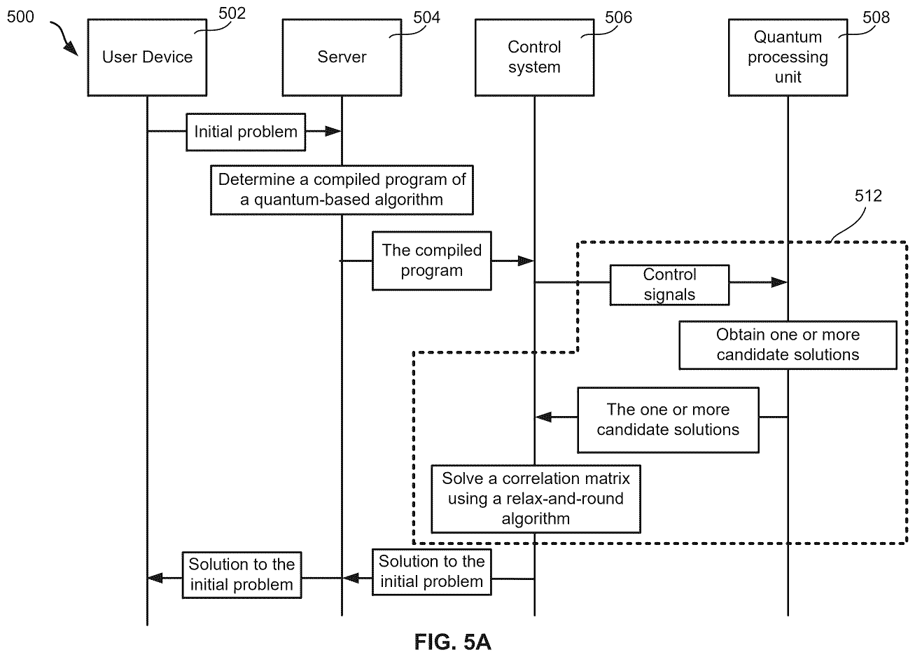

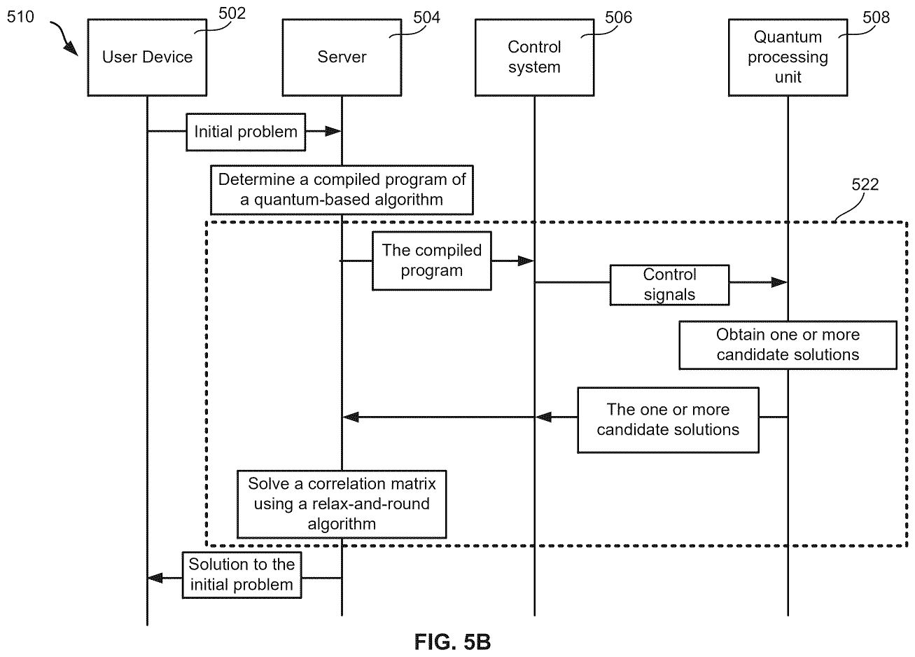

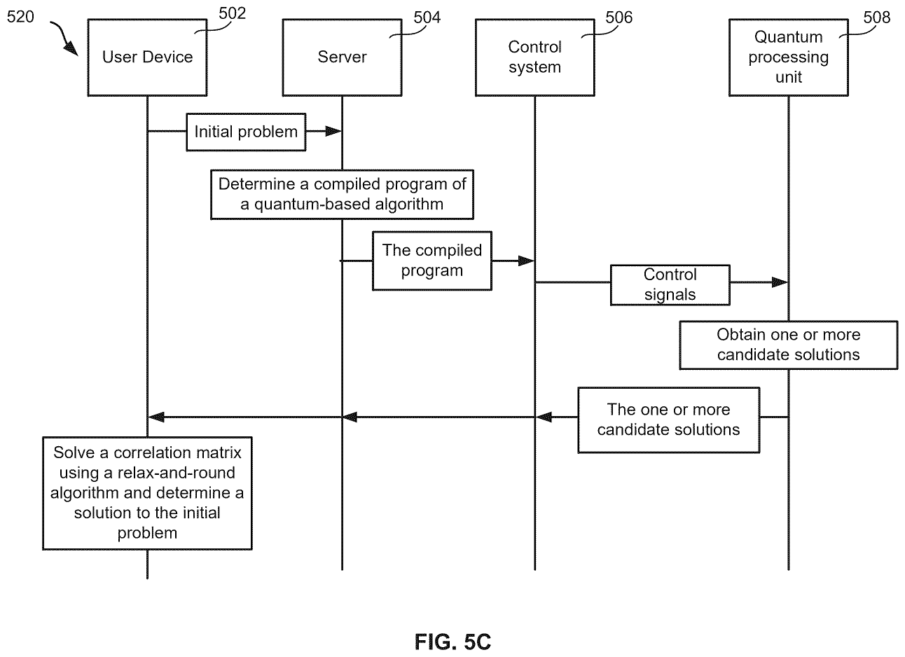

At 204, an initial algorithm to solve the initial problem is executed. In some implementations, the initial algorithm is a quantum-based algorithm which may run in a hybrid fashion between the quantum processing unit (QPU) 508 and the classical hardware of the control system 506 (e.g., the FPGA on the rack of the quantum processing unit), the servers 504 (e.g., within the cloud of the quantum computing system), or the client device 502 as shown in FIGS. 5A-5C. The classical hardware 502, 504, 506 and the QPU 508 may be connected via a communication channel, e.g., a networking device, a communication bus, pins shared memory, etc.

For example, when the initial algorithm is a QAOA with p layers, execution of the QAOA to solve the initial problem generates a list of candidate solutions. In some instances, the execution of the initial algorithm includes statistics (e.g., correlation between variables or other statistics). For example, when the initial algorithm includes a quantum logic circuit which can be solved analytically, statistics may be directly computed. An example computation of the statistics is described in the publication “Quantum approximate optimization algorithm for MaxCut: A fermionic view”, by Wang et al., Phys. Rev. A 97, 022304, Feb. 5, 2018, which is hereby incorporated by reference in the present disclosure. In some instances, the output of the initial algorithm may include other types of data.

At 206, a correlation matrix is generated based on the list of candidate solutions obtained from the execution of the initial algorithm. For example, when a number of candidate solutions each having a number of variables is returned from executing the initial algorithm, correlations between two or more variables in the candidate solutions can be used to determine elements of the correlation matrix Z. In some instances, correlations between two or more variables of the initial problem or other types of statistics can be directly output from the initial algorithm. In this case, the elements of the correlation matrix Z can be directly built based on the output of the initial algorithm.

In some implementations, the correlation matrix Z encodes a preconditioned problem which is distinct from the initial problem. In other words, execution of the initial algorithm for solving the initial problem preconditions the initial problem; and generates a preconditioned problem which is encoded in the correlation matrix Z. In some implementations, elements of the correlation matrix Z represents correlation coefficient between variables; and values of the elements is in a range between −1 and +1 indicating the strength and direction of the relationship. In some implementations, outputs of a quantum-based algorithm (e.g., executing a quantum logic circuit) correspond to variables of the initial problem; and are measurements of respective qubits in respective computational basis. In certain instances, correlation between variables may be determined based on measurements of corresponding qubits in the same computational basis or different computational basis. In some implementations, a correlation matrix Z includes elements \hat{Z}ᵢⱼ that are defined by expectation values of Pauli observables. For example, a correlation matrix Z may include elements \hat{Z}ᵢⱼ which is defined as (δᵢⱼ−1) [symbol] \hat{Z}ᵢ\hat{Z}ⱼ [symbol] where [symbol] \hat{Z}ᵢ\hat{Z}ⱼ [symbol] is the expectation value of the two-point correlation involving the Pauli operators \hat{Z}ᵢ and \hat{Z}ⱼ measured on qubits i and j corresponding to variables i and j. In some instances, the expectation value of the two-point correlation [symbol] \hat{Z}ᵢ\hat{Z}ⱼ [symbol] can be determined as

$$〈 {\hat{Z}}_{i} {\hat{Z}}_{j} 〉 = \frac{1}{K} {\sum }_{k = 1}^{K} {s}_{i}^{( k )} {s}_{j}^{( k )} \qquad ( 1 )$$

where

$${s}_{i}^{( k )} and {s}_{j}^{( k )}$$

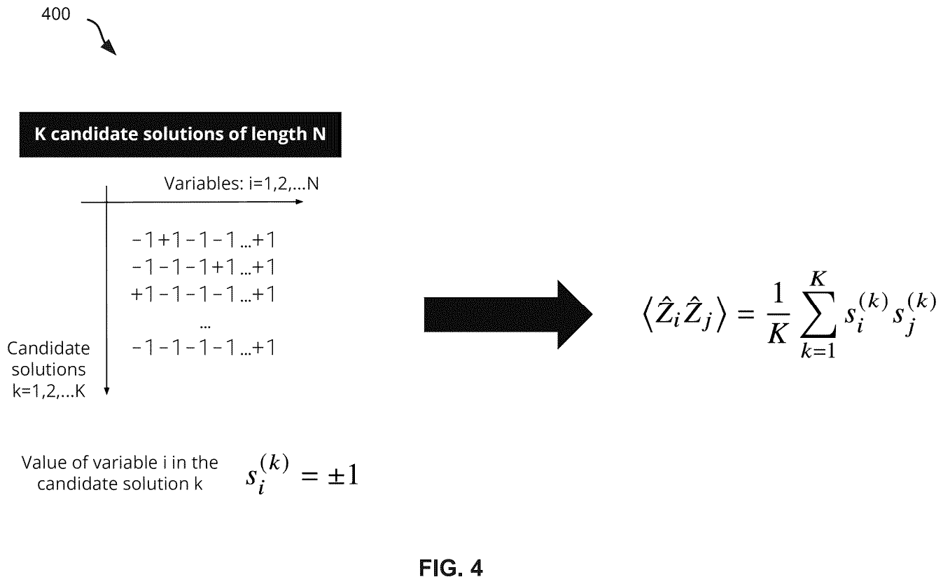

represent values of variables i, j in the candidate solution k, as shown in FIG. 4. In some instances, the expectation values of the two-point correlation [symbol] \hat{Z}ᵢ\hat{Z}ⱼ [symbol] may be determined in another manner.

For another example, a correlation matrix Z may include elements \hat{Z}ᵢⱼ which is defined as a function of expectation value of two-point correlation involving Pauli operators \hat{X}ᵢ and \hat{Z}ⱼ measured on qubits i and j corresponding to variables i and j. In some instances, elements of the correlation matrix may include expectation values of Pauli observables in other combinations. In some instances, elements of the correlation matrix may not be defined differently from one another. In some instances, the outputs of a quantum-based algorithm may include measurements taken in other basis, such as random vectors on the single-qubit Bloch sphere or a random selection of a finite collection of vectors on the single-qubit Bloch sphere, or the multi-qubit equivalents, that may allow for more efficient reconstruction of certain observables.

At 208, a relax-and-round algorithm is executed to solve the preconditioned problem. In some implementations, the relax-and-round algorithm includes steps such as performing an eigen-decomposition of the correlation matrix Z to obtain its normalized eigenvectors; rounding the individual components of each eigenvector to ±1 depending on its sign; and looping over the rounded eigenvectors and identifying the one with the best score with respect to the initial problem, which is the solution returned by the relax-and-round algorithm. In some instances, a specific subset of eigenvectors of the correlation matrix Z may be targeted instead of all of the eigenvectors. For instance, the leading eigenvector of the matrix Z may be obtained and used; and a dedicated linear algebra method can be used to compute the leading eigenvector directly (e.g., based on the power method like the Lanczos algorithm). In some instances, other methods to solve the correlation matrix can be used; and other types of data may be used to determine the solution to the initial problem.

In some implementations, before rounding values of the components of each eigenvector to ±1 depending on its sign, one or more components of an eigenvector that has a value close to zero is identified and labeled. For example, when the absolute value of a component eᵢ of the eigenvector is equal to or less than a predetermined threshold value ε, e.g., |eᵢ|≤ε, where ε may be equal to 0.1, 0.05, 0.01 or another value. The one or more components can be identified and labeled as “less sure of their actual sign.” Operations including identifying the one with the best score with respect to the initial problem can be performed. In some implementations, signs of the one or more labeled components are then flipped, e.g., +1 to −1 or −1 to 1; and evaluation of whether a flipped sign of a respective labeled component results in an enhanced solution can be iteratively performed. In some implementations, an order to flip the signs of the one or more labeled components is determined according to a predefined criterion. For example, a criterion may allow a selection of a random component from the one or more labeled components and flip its sign. In this case, the one or more labeled components may be selected randomly and uniformly. In other words, the probability of a component within the one or more labeled components being selected is pᵢ=1/N, where N is the number of the one or more labeled components. For another example, a criterion may allow a preferred selection of components from the one or more labeled components. For instances, a first subset of components with smallest absolute values may be selected and effects of flipping signs of the first subset of components may be evaluated first; and a second subset of components with greater absolute values may then be selected and effects of flipping signs of the second subset of components may then be evaluated. In other words, a probability of a component being selected may be defined by its absolute value, e.g., pᵢ=|eᵢ|⁻¹/Σᵢ|eᵢ|⁻¹. In some instances, the one or more labeled components may be selected and flipped in another manner.

In some implementations, performing an eigen-decomposition of the correlation matrix Z during the execution of the relax-and-round algorithm determines first k leading eigenvectors, where k is a positive integer; and a classical algorithm is executed to perform clustering based on the first k leading eigenvectors which correspond to the leading k eigenvalues (e.g., smallest or largest). In some instances, the classical algorithm may be a k-means clustering method, or other classical algorithms. In some instances, a k-means clustering method enables the partition of the problem variables into k groups, extending the naïve sign-rounding (e.g., two categories, +1 and −1, respectively) to more, as potentially defined by the original optimization problem. In that context, a solution returned by a k-means clustering method, or other, corresponds to a solution to the original optimization problem.

In some cases, the operations 204, 206, 208 (and possibly other operations) within the example process 200 are executed as an iterative process. Each iteration includes generating output by running the initial algorithm, determining the preconditioned problem, and solving the preconditioned problem to determine a solution. For example, the solution from the execution of the relax-and-round algorithm for solving the preconditioned problem during operation 208 may be feedback as input to the operation 204 where the solution may be used as a starting point for the initial algorithm. In some instances, when the iterative process does not further improve the accuracy of the solution, the iterative process can terminate. Each iteration of the iterative process may include additional operations and parameter evaluations.

FIG. 3 is a flowchart showing aspects of an example process 300. In some instances, the example process 300 may be performed by the computer system 100 shown in FIG. 1 or another type of computer system for determining a solution to an initial problem. In some implementations, the example process 300 utilizes results from a quantum-based algorithm in a relax-and-round algorithm. In some implementations, the example process 300 describes a quantum-assisted preconditioning of an initial optimization problem to generate a preconditioned optimization problem; and solving the preconditioned optimization problem using a relax-and-round algorithm. In other words, the example process 300 is a quantum-assisted relax-and-round algorithm.

At 302, an initial problem is obtained. The initial problem may be an optimization problem, which may include quadratic unconstrained binary optimization (QUBO) problems and may have applications in finance optimization, routing, scheduling, economics, machine learning, science, and the like. In some instances, the initial problem may be other types of optimization problems as well as machine learning techniques, quantum machine learning techniques, variational quantum algorithms, workflows, or other problems. In some instances, the initial problem may be encoded in an initial matrix, W.

At 304, a quantum-based algorithm is executed to solve the initial problem. One example of a quantum-based algorithm is a quantum approximation algorithm (QAOA), which is a type of hybrid classical/quantum machine learning algorithm (commonly used for optimization problems). A QAOA may include a parameterized quantum logic circuit with p layers, where parameters of quantum logic gates in the parameterized quantum logic circuit are selected such that the sampled output of the parameterized quantum circuit returns candidate solutions when executed on a quantum computing resource, with respect to the initial problem. In some instances, a quantum-based algorithm includes a Variational Quantum Eigensolver (VQE), which is also a class of parameterized quantum circuit constructions that typically include data encoding for circuit parameters that reflects symmetries in the problem domain, such as the Jordan-Wigner transformation which can encode fermionic degrees of freedom. In some instances, a quantum-based algorithm may include a parameterized quantum circuit that embeds classical data in parameters analogous and have gates and other operations that are parameterized analogously to weights of conventional neural network layers. In some instances, a quantum-based algorithm includes a quantum kernel method that encodes data and estimates the similarity of that data to other data. In some instances, the outputs of quantum-based algorithms may be measurements in the computational basis or may include measurements taken in other basis, such as random vectors on the single-qubit Bloch sphere or a random selection of a finite collection of vectors on the single-qubit Bloch sphere, or the multi-qubit equivalents, that may allow for more efficient reconstruction of certain observables. For example, the initial problem may be an optimization problem; and the quantum-based algorithm includes a single layer QAOA quantum circuit. The initial algorithm may be another variational algorithm. In some instances, the initial algorithm may be an adiabatic quantum algorithm, or a quantum annealer. In some instances, a quantum computing resource for execution of the quantum-based algorithm includes one or more quantum processing units (102A, 102B) of a quantum computing system 103A, 103B, a quantum simulator, or a hybrid computer system.

At 306, a list of candidate solutions to the initial problem is returned by the computer system from the execution of the quantum-based algorithm. In some implementations, each candidate solution may be represented as a string of bits displayed as 0 and 1. The output may, for example, be a list of solutions (bit strings). On an ideal quantum computer, the solutions may be as close to optimal as possible, but this is not practically true because of noise in the QPU, which impacts the correctness of the results. In some instances, the quantum-based algorithm may include additional error mitigation or correction strategies to improve its output, for example virtual distillation may leverage multiple physical copies of the quantum-based algorithm simultaneously with controlled-SWAP or equivalent operations between copies to improve the error rates. Another example error mitigation strategy could reduce bias in the sampled output by include twirling of individual quantum circuit layers or operations, for instance using Pauli twirling with randomized compilation for multi-qubit gates or randomizing the readout basis.

The number of candidate solutions is a parameter. In some instances, the number of candidate solutions is large enough for computing relevant statistics from the list of candidate solutions. For example, the minimum number of candidate solutions can be determined by running the initial algorithm for an increasing number of candidate solutions until convergence.

At 308, relevant features of the list of the candidate solutions are captured to generate a preconditioned problem. In some instances, the relevant features may include relevant statistics. For example, candidate solutions are used to compute the average expectation value of two-point correlations between variables of the optimization problem. In particular, [symbol] \hat{Z}ᵢ\hat{Z}ⱼ [symbol] is the expectation value of the two-point correlation involving the Pauli operators \hat{Z}ᵢ and \hat{Z}ⱼ on variables i and j in the candidate solutions. It is possible for the quantum-based algorithm used to directly return the expectation value of two-point correlations between variables of the initial optimization problem without returning explicitly candidate solutions (e.g., in this case, the operation 306 may be optional). In some implementations, the relevant features are correlations between variables of the initial problem, computed, for instance from candidate solutions or directly as output of execution of the initial algorithm on the initial problem. In some instances, higher-order correlations between variables in the candidate solutions may be used to construct the preconditioned problem. In some instances, correlations based on different observables may be used or may be obtained in another manner. In some implementations, the correlations are obtained based on the expectation values of observables. In certain examples, features of the initial problem and features of a first preconditioned problem may be mixed to determine a second preconditioned problem.

At 310, a new matrix representing the preconditioned problem is constructed. In some instances, values of the two-point correlations are tabulated to determine elements of the new matrix Z, e.g., a correlation matrix. In some instances, the new matrix Z has a size of N×N. The new matrix Z encodes the preconditioned optimization problem based on the candidate solutions from the initial optimization problem represented by the matrix W. In some implementations, the new matrix Z is real and symmetric. In some instances, the expectation value of two-point correlations between the variables in the candidate solutions of the initial optimization problem can capture the relevant features of the initial optimization problem.

For example, when K candidate solutions of length N are determined from running the QAOA algorithm, elements of a correlation matrix encoding the preconditioned problem may be obtained using the example method 400 shown in FIG. 4 which is based on two-point correlations of variables or in another manner.

At 312, a relax-and-round algorithm is used on the new matrix Z to solve the preconditioned optimization problem. A solution of the relax-and-round algorithm is also a candidate solution for the initial problem and may have a higher quality than the list of candidate solutions obtained from the initial algorithm. The relax-and-round algorithm deals efficiently with features that would otherwise be too hard to handle. Such features include, for instance, some hard constraints. In some implementations, hard constraints are such that if a solution does not fulfill them, it is an invalid solution, independent of its score.

The matrix Z can represent an adjacency matrix of a weighted graph with the weights given by the average expectation value of two-point correlations between variables. In some implementations, a “relax-and-round” algorithm can group variables which are positively correlated into the same cluster, and other variables which are negatively correlated into a different cluster.

In some implementations, a relax-and-round algorithm includes doing an eigen decomposition of the new matrix Z. Its eigenvectors are then rounded and looped over to compute the score of each of the eigenvectors with respect to the initial combinatorial optimization problem. The rounded eigenvector leading to the best score is the solution returned by the relax-and-round algorithm to the preconditioned and the initial problems. In some implementations, performing the operation 312 may be implemented as the operation 208 in the example process 200 shown in FIG. 2 or in another manner.

In some implementations, the methods and techniques presented here can provide a better solution to combinatorial optimization problems than standard “relax-and-round” approaches, which are purely classical (as opposed to quantum), and often some of the best methods for solving combinatorial optimization problems otherwise available. The methods and techniques presented here can provide a better solution than other quantum optimization algorithms such as the QAOA as well as other variational and adiabatic approaches, for combinatorial optimization problems. The methods and techniques presented here can also provide a better solution than other classical methods. In certain examples, the methods and techniques presented here may result in a different optimal solution from the one to the initial problem, but can facilitate a determination of a good, non-optimal solution to the initial problem.

In some implementations, the methods and techniques presented here can leverage error mitigation techniques based on the expectation value of observables. Such error mitigation techniques are typically not usable in standard quantum optimization algorithms such as the QAOA as well as other variational and adiabatic approaches. The reason is that optimization algorithms seek to find a unique solution while expectation-based error mitigation techniques work over an ensemble of solutions to mitigate global statistical properties of that ensemble and not mitigate its individual solutions. In some instances, the preconditioned optimization problem is built from expectation values. In some instances, the methods and techniques presented here are robust to depolarizing noise which may rescale all expectation values. Such a rescaling factor has no effect on the developed quantum-assisted “relax-and-round” approach since such a rescaling factor leaves eigenvectors unchanged. In some instances, the methods and techniques presented here can also provide other advantages.

In some instances, the solution from the relax-and-round algorithm can be used as input to the execution of the quantum-based algorithm during the operation 304. In other words, the operations 304, 306, 308, 310, 312 may be performed iteratively to improve the quality of the solution.

FIGS. 5A-5C are ladder diagrams showing aspects of example processes 500, 510, 520. The example processes 500, 510, 520 can be performed in the example computing environment 100 in FIG. 1. The computing environment includes a hybrid computer system which includes a user device 502, a server 504, a control system 506, and a quantum processing unit 508. The user device 502 submits an initial optimization problem to the server 504. After receiving the initial optimization problem, the server 504 determines a compiled program of a quantum-based algorithm that can be executed on the quantum processing unit 508. The compiled program is then communicated from the server 504 to the control system 506 of a quantum computing system. The control system 506, based on the compiled program, determines a sequence of control signals to be applied to quantum circuit devices of the quantum processing unit 508 to execute the quantum-based algorithm to precondition the initial optimization problem. The quantum processing unit 508 produces one or more candidate solutions to the initial optimization problem. The one or more solutions are then communicated back to the control system 506; and are used to construct a preconditioned optimization problem represented by a correlation matrix, by the control system 506 (e.g., FPGA). The correlation matrix can be solved using a relax-and-round algorithm, during which output of the relax-and-round algorithm which represents a solution to the initial problem can be determined and communicated back to the server 504 and further to the user device 502.

As shown in FIG. 5B, the one or more candidate solutions can be further communicated from the control system 506 to the server 504, on which the relax-and-round algorithm can be executed to determine a solution to the initial problem. As shown in FIG. 5C, the one or more candidate solutions are further communicated from the control system 506 to the user device 502 via the server 504. The relax-and-round algorithm can be executed on the user device 502 to determine a solution to the initial problem.

In some implementations, operations (in box 512 of FIG. 5A and box 522 in FIG. 5B) can be executed iteratively. Each iteration includes generating output by running the quantum-based algorithm, determining the preconditioned problem, and solving the preconditioned problem to determine a solution. For example, the solution from the relax-and-round algorithm to solve the preconditioned problem may be feedback as input to the control system 506 where the solution may be used as a starting point for the quantum-based algorithm. In some instances, when the iterative process does not further improve the accuracy of the solution, the iterative process can terminate. Each iteration of the iterative process may include additional operations and parameter evaluations.

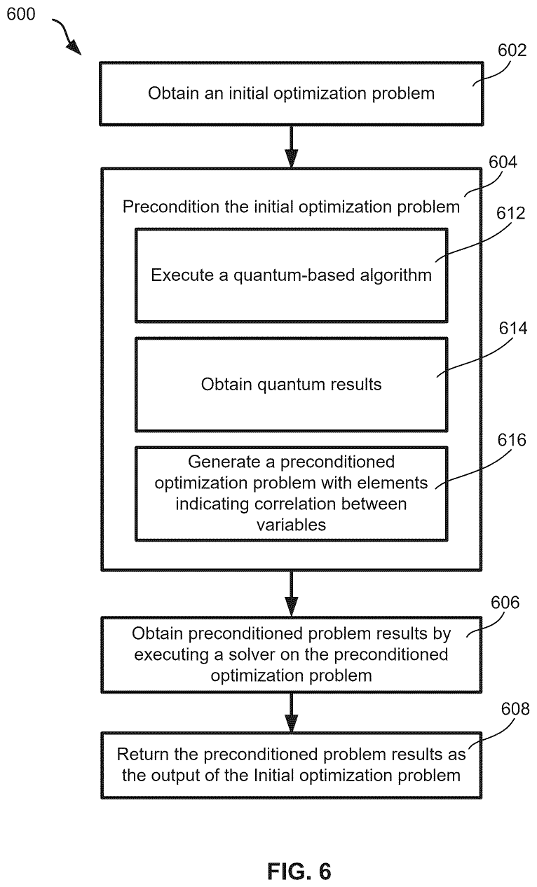

FIG. 6 is a flowchart showing aspects of an example process 600. In some instances, the example process 600 can be performed by the computer system 100 shown in FIG. 1, or another type of computer system for determining a solution to an optimization problem or another type of problem. In some implementations, the example process 300 describes a quantum-assisted preconditioning of an initial optimization problem to generate a preconditioned optimization problem; and solving the preconditioned optimization problem using a solver to obtain a solution to the initial optimization problem.

At 602, an initial optimization problem to be solved is obtained by the computer system. In some implementations, the initial optimization problem includes a quadratic binary optimization (QUBO) problem. In some implementations, operation 602 may be implemented as the operation 202, 302 in FIGS. 2-3 or in another manner.

At 604, the initial optimization problem is preconditioned. In some implementations, a quantum-based algorithm is determined and used to precondition the initial optimization problem. The quantum-based algorithm can be pre-determined or obtained according to the initial optimization problem. In some instances, the quantum-based algorithm can be determined based on the quantum computing resources, the number of variables associated with the initial optimization problem or other factors. When the quantum-based algorithm is obtained and then executed, quantum results associated with solutions of the initial optimization problem can be determined. The quantum results can then be used to generate a preconditioned optimization problem which is described by correlations between variables associated with the initial optimization problem. The preconditioned optimization problem can then be solved by a solver, either classical or quantum, to obtain the solution to the initial optimization problem. As shown in FIG. 6, the operation 604 includes sub-operations 612, during which the quantum-based algorithm is executed; sub-operation 614, during which the quantum results from the execution of the quantum-based algorithm are obtained; and sub-operation 618, during which the preconditioned optimization problem is generated.

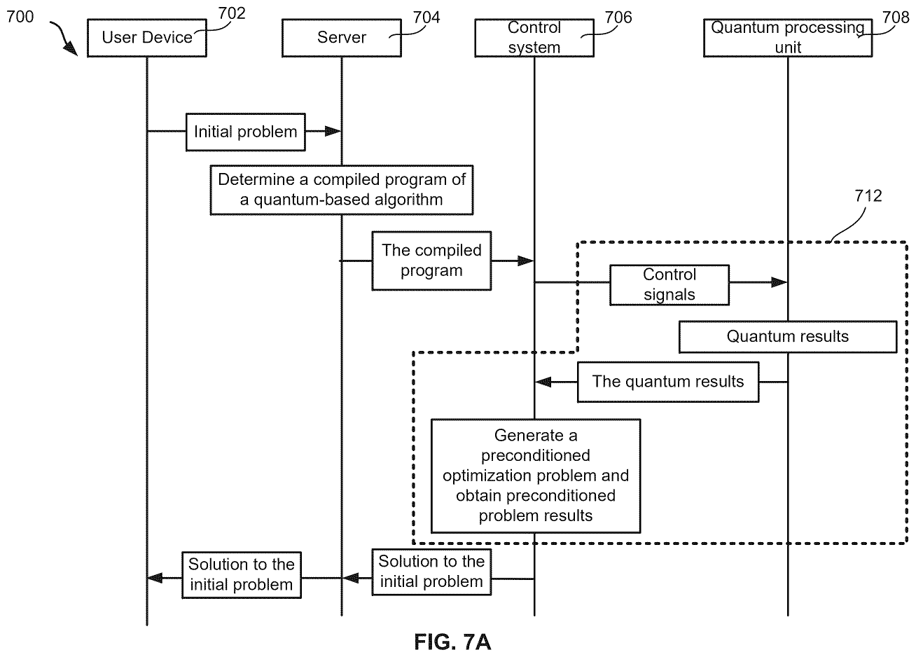

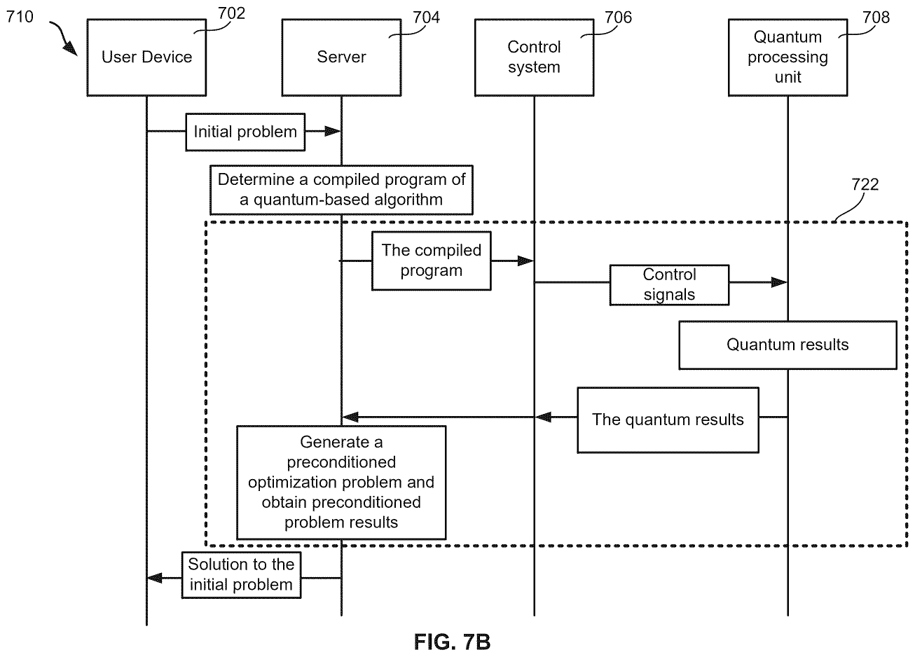

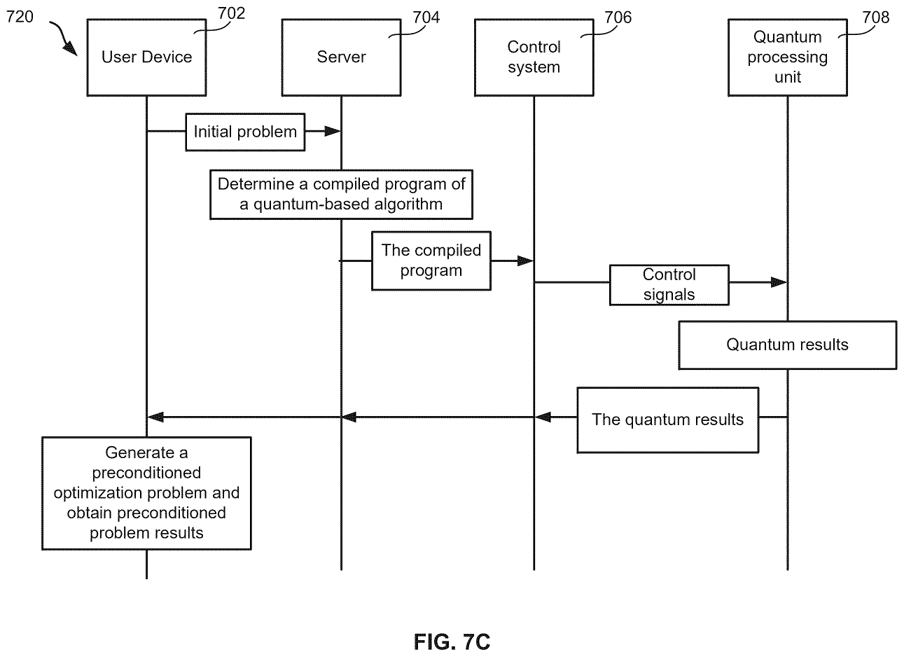

At 612, the quantum-based algorithm is executed. In some instances, the quantum-based algorithm may run in a hybrid fashion between the quantum processing unit (QPU) 708 and the classical hardware of the control system 706 (e.g., the FPGA on the rack of the quantum processing unit), the servers 704 (e.g., within the cloud of the quantum computing system), or the client device 702 as shown in FIGS. 7A-7C. The classical hardware and the QPU may be connected via a communication channel, e.g., a networking device, a communication bus, pins shared memory, etc. In some instances, the quantum-based algorithm may be performed by operating a quantum simulator. In some cases, the quantum-based algorithm is executed to perform a quantum-assisted preconditioning of the initial optimization problem. The quantum-based algorithm may be a QAOA with p layers, a VQE algorithm, an adiabatic quantum algorithm, a quantum annealer, or another quantum-based algorithm. In some instances, the quantum-based algorithm is executed by applying a quantum logic circuit on qubits associated with the variables of the initial optimization problem. The quantum logic circuit includes a sequence of quantum logic operations that can be applied to the qubits to perform the quantum-based algorithm. In some examples, the quantum logic operations can be expressed as single-qubit quantum logic gates, two-qubit quantum logic gates, or other types of quantum logic gates that operate on one or more qubits. Execution of the quantum-based algorithm may include translating the quantum logic circuit into a sequence of native quantum logic gates that can be executed on the quantum processing unit of the quantum computing system; and communicating control signals to the quantum processing unit for executing the sequence of native quantum logic gates. In some instances, the sub-operation 612 may be implemented as the operation 204 in the example process 200 of FIG. 2 or in another manner.

At 614, quantum results are obtained. In some implementations, the quantum results are obtained by executing the quantum-based algorithm and performing measurements on the qubits. The quantum results may be represented as a string of bits. In some instances, operation 614 may be implemented as the operation 306 of the example process 300 shown in FIG. 3 or in another manner.

At 616, a preconditioned optimization problem is generated. In some instances, the preconditioned optimization problem is represented by a matrix with elements indicating correlation between variables in the initial optimization problem. For example, multiple bit strings each having a number of variables are returned as the quantum results from executing the quantum-based algorithm, correlations between two or more variables in the quantum results can be used to determine the elements of the matrix (e.g., a correlation matrix Z). In some instances, correlations between two or more variables of the initial problem or other types of statistics can be directly output from the initial algorithm. In this case, the elements of the correlation matrix Z can be directly built based on the output of the initial algorithm. In some instances, the operation 616 may be implemented as the operation 206 in the example process 200 shown in FIG. 2, operations 308, 310 of the example process 300 shown in FIG. 3, or in another manner.

At 606, preconditioned problem results are obtained. In some implementations, the preconditioned problem results are obtained by executing a solver on the preconditioned optimization problem. In some instances, the solver may be a semidefinite programming method. In some instances, a semidefinite programming method can be also used which may involve operations including building the new matrix Z from the candidate solutions; ensuring the new matrix Z having required properties of semidefinite programming (e.g., positive semidefinite); and using the semidefinite programming solver on the new matrix Z to find a solution to the initial problem. In some instances, prior to executing the solver, the matrix Z may be transformed to ensure the transformed matrix Z having the properties required by semidefinite programming method (e.g., positive semidefinite). When the solver is a relax-and-round algorithm, operation 606 may be implemented as the operations 208, 312 of the example processes 200, 300 shown in FIGS. 2-3. In some instances, the solver may be simulated annealing method, Burer-Monteiro, or another classical solver. In some instances, executing the solver may include executing a quantum-based algorithm, for example the quantum-based algorithm for preconditioning the initial optimization problem. In some implementations, execution of the solver on the preconditioned optimization problem produces the preconditioned problem results associated with one or more solutions to the preconditioned optimization problem.

In some cases, the operations 612, 614, 616 (and possibly other operations) within the example process 600 are executed as an iterative process. Each iteration includes generating one or more quantum results by running the quantum-based algorithm, determining the preconditioned optimization problem, and solving the preconditioned optimization problem by applying the solver to determine preconditioned problem results. For example, the solution from the relax-and-round algorithm to solve the preconditioned optimization problem during operation 616 may be feedback as input to the operation 612 where the solution may be used as a starting point for the quantum-based algorithm. In some instances, when the iterative process does not further improve the accuracy of the solution, the iterative process can be terminated. Each iteration of the iterative process may include additional operations and parameter evaluations.

At 608, the preconditioned problem results are returned as the output of the initial optimization problem. In some instances, the preconditioned problem results from solving the preconditioned optimization problem may be different from the optimal solution to the initial optimization problem. In other words, the optimal solution of the precondition optimization problem obtained by applying the solver may not be the optimal solution to the initial optimization problem. In some implementations, the systems and techniques can facilitate the finding of a good, yet nonoptimal, solution to the initial optimization problem. In some implementations, the initial optimization problem and preconditioned optimization problems share the same optimal solution in the limit of a large number of QAOA layers.

FIGS. 7A-7C are ladder diagrams showing aspects of example processes 700, 710, 720. The example processes 700, 710, 720 can be performed in the example computing environment 100 in FIG. 1. The computing environment includes a hybrid computer system which includes a user device 702, a server 704, a control system 706, and a quantum processing unit 708. The user device 702 submits an initial optimization problem to the server 704. After receiving the initial optimization problem, the server 704 determines a compiled program of a quantum-based algorithm that can be executed on the quantum processing unit 708. The compiled program is then communicated from the server 704 to the control system 706 of a quantum computing system. The control system 706, based on the compiled program, determines a sequence of control signals to be applied to quantum circuit devices of the quantum processing unit 708 to execute the quantum-based algorithm to precondition the initial optimization problem. The quantum processing unit 708 produces quantum results representing solutions to the initial optimization problem.

As shown in FIG. 7A, the quantum results are then communicated back to the control system 706; and are used to generate a preconditioned optimization problem by operation of the control system 706. The preconditioned optimization problem can be solved using a solver, during which preconditioned problem results from applying the solver on the preconditioned optimization problem which represents one or more solutions to the initial optimization problem can be determined and communicated back to the server 704 and further to the user device 702. As shown in FIG. 7B, the quantum results can be further communicated from the control system 706 to the server 704, on which the solver can be executed to determine one or more solutions to the initial optimization problem. As shown in FIG. 7C, the quantum results are further communicated from the control system 706 to the user device 702 via the server 704. The solver can be executed on the user device 502 to determine the one or more solutions to the initial optimization problem.

In some implementations, operations (in box 712 of FIG. 7A and box 722 in FIG. 7B) can be executed iteratively. Each iteration includes generating the quantum results by running the quantum-based algorithm, determining the preconditioned optimization problem, and solving the preconditioned optimization problem to determine preconditioned problem results. For example, the quantum results from solving the preconditioned optimization problem may be feedback as input to the control system 706 where the quantum results may be used as a starting point for the quantum-based algorithm. In some instances, when the iterative process does not further improve the accuracy of the solution, the iterative process can terminate. Each iteration of the iterative process may include additional operations and parameter evaluations.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

In a general aspect, a quantum-assisted preconditioning of optimization problems is presented.

In a first example, a method of generating an output of an optimization problem by operation of a computer system including a classical computing resource in communication with a quantum computing resource is presented. The method includes obtaining an initial optimization problem; and preconditioning the initial optimization problem including causing the quantum computing resource to execute a quantum-based algorithm corresponding to the initial optimization problem; obtaining quantum results based the execution of the quantum-based algorithm, the quantum results being indicative of one or more solutions to the initial optimization problem as determined by the quantum-based algorithm; and based on the quantum results, by operation of the classical computing resource, generating a preconditioned optimization problem comprising elements indicative of correlations between variables associated with the initial optimization problem. The method further includes obtaining preconditioned problem results based on an execution of a solver on the preconditioned optimization problem; and returning the preconditioned problem results as the output of the initial optimization problem.

Implementations of the first example may include one or more of the following features. The quantum computing resource includes at least one of a quantum simulator, a quantum computing system, or a hybrid computer system. The solver includes a semidefinite programing method. The semidefinite programming method includes a relax-and-round algorithm, generating the preconditioned optimization problem includes constructing a matrix, and executing the solver on the preconditioned optimization problem includes performing the relax-and-round algorithm by operation of the classical computing resource on the matrix.

Implementations of the first example may include one or more of the following features. The solver includes a simulated annealing method. The solver includes the quantum-based algorithm, and executing the solver on the preconditioned optimization problem includes causing the quantum computing resource to execute the quantum-based algorithm. The quantum-based algorithm includes a quantum approximate optimization algorithm (QAOA) executed by the computer system. The quantum-based algorithm includes a variational quantum eigensolver (VQE) algorithm executed by the computer system.

Implementations of the first example may include one or more of the following features. The initial optimization problem includes a quadratic binary optimization (QUBO) problem. Generating the preconditioned optimization problem includes constructing a matrix based on the one or more solutions to the initial optimization problem. Generating the preconditioned optimization problem includes constructing a matrix, and each element of the matrix includes an expected value of a two-point correlation between operators of the respective variables. Generating the preconditioned optimization problem includes constructing an adjacency matrix of a weighted graph. Generating the preconditioned optimization problem includes constructing a matrix, and executing the solver on the preconditioned optimization problem includes performing an eigen-decomposition of the matrix. Performing the eigen-decomposition of the matrix includes determining a leading eigenvector, the method further includes rounding each entry of the leading eigenvector to ±1 depending on its sign. Performing the eigen-decomposition of the matrix includes determining k leading eigenvectors; and using a classical algorithm for performing clustering based on the k leading eigenvectors. The classical algorithm comprises a k-means clustering method.

In a second example, a computer system includes a quantum computing resource and a classical computing resource which includes one or more classical processing units and memory storing instructions that when executed by the one or more classical processing units cause the one or more classical processing units to perform operations including obtaining an initial optimization problem; and preconditioning the initial optimization problem. Preconditioning the initial optimization problem includes causing the quantum computing resources to execute a quantum-based algorithm corresponding to the initial optimization problem; obtaining quantum results based the execution of the quantum-based algorithm, the quantum results being indicative of one or more solutions to the initial optimization problem as determined by the quantum-based algorithm; and based on the quantum results, by operation of the classical computing resource, generating a preconditioned optimization problem comprising elements indicative of correlations between variables associated with the initial optimization problem. The operations further include obtaining preconditioned problem results based on an execution of a solver on the preconditioned optimization problem; and returning the preconditioned problem results as the output of the initial optimization problem.

Implementations of the second example may include one or more of the following features. The quantum computing resource includes at least one of a quantum simulator, a quantum computing system, or a hybrid computer system. The solver includes a semidefinite programing method. The semidefinite programming method includes a relax-and-round algorithm, generating the preconditioned optimization problem includes constructing a matrix, and executing the solver on the preconditioned optimization problem includes performing the relax-and-round algorithm by operation of the classical computing resource on the matrix.

Implementations of the second example may include one or more of the following features. The solver includes a simulated annealing method. The solver includes the quantum-based algorithm, and executing the solver on the preconditioned optimization problem includes causing the quantum computing resource to execute the quantum-based algorithm. The quantum-based algorithm includes a quantum approximate optimization algorithm (QAOA) executed by the computer system. The quantum-based algorithm includes a variational quantum eigensolver (VQE) algorithm executed by the computer system.

Implementations of the second example may include one or more of the following features. The initial optimization problem includes a quadratic binary optimization (QUBO) problem. Generating the preconditioned optimization problem includes constructing a matrix based on the one or more solutions to the initial optimization problem. Generating the preconditioned optimization problem includes constructing a matrix, and each element of the matrix includes an expected value of a two-point correlation between operators of the respective variables. Generating the preconditioned optimization problem includes constructing an adjacency matrix of a weighted graph. Generating the preconditioned optimization problem includes constructing a matrix, and executing the solver on the preconditioned optimization problem includes performing an eigen-decomposition of the matrix. Performing the eigen-decomposition of the matrix includes determining a leading eigenvector, the method further includes rounding each entry of the leading eigenvector to ±1 depending on its sign. Performing the eigen-decomposition of the matrix includes determining k leading eigenvectors; and using a classical algorithm for performing clustering based on the k leading eigenvectors. The classical algorithm comprises a k-means clustering method.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method of generating an output of an optimization problem by operation of a computer system, the computer system comprising a classical computing resource in communication with a quantum computing resource, the method comprising:
obtaining, at the computer system, an initial optimization problem;
preconditioning the initial optimization problem, comprising:
causing the quantum computing resource to execute a quantum-based algorithm corresponding to the initial optimization problem;
obtaining quantum results based on the execution of the quantum-based algorithm, the quantum results being indicative of one or more solutions to the initial optimization problem as determined by the quantum-based algorithm; and
based on the quantum results, by operation of the classical computing resource, generating a preconditioned optimization problem comprising elements indicative of correlations between variables associated with the initial optimization problem;
obtaining preconditioned problem results based on an execution of a solver on the preconditioned optimization problem; and
returning the preconditioned problem results as the output of the initial optimization problem.

2. The method of claim 1, wherein the solver comprises a semidefinite programming method.

3. The method of claim 2, wherein the semidefinite programming method comprises a relax-and-round algorithm, generating the preconditioned optimization problem comprises constructing a matrix, and executing the solver on the preconditioned optimization problem comprises performing the relax-and-round algorithm by operation of the classical computing resource on the matrix.

4. The method of claim 1, wherein the solver comprises the quantum-based algorithm, and executing the solver on the preconditioned optimization problem comprises causing the quantum computing resource to execute the quantum-based algorithm.

5. The method of claim 4, wherein the quantum-based algorithm comprises a quantum approximate optimization algorithm (QAOA) executed by the computer system.

6. The method of claim 4, wherein the quantum-based algorithm comprises a variational quantum eigensolver (VQE) algorithm executed by the computer system.

7. The method of claim 1, wherein generating the preconditioned optimization problem comprises constructing a matrix, and executing the solver on the preconditioned optimization problem comprises performing an eigen-decomposition of the matrix.

8. The method of claim 7, wherein performing the eigen-decomposition of the matrix comprises determining a leading eigenvector, and the method comprises rounding each entry of the leading eigenvector to ±1 depending on its sign.

9. The method of claim 7, wherein performing the eigen-decomposition of the matrix comprises:
determining k leading eigenvectors, where k is a positive integer; and
using a classical algorithm to perform clustering based on the k leading eigenvectors.

10. The method of claim 9, wherein the classical algorithm comprises a k-means clustering method.

11. The method of claim 1, wherein the initial optimization problem comprises a quadratic binary optimization (QUBO) problem.

12. The method of claim 1, wherein generating the preconditioned optimization problem comprises constructing a matrix based on the one or more solutions to the initial optimization problem.

13. The method of claim 1, wherein generating the preconditioned optimization problem comprises constructing a matrix, and each element of the matrix comprises an expected value of a two-point correlation between operators of the respective variables.

14. The method of claim 1, wherein generating the preconditioned optimization problem comprises constructing an adjacency matrix of a weighted graph.

15. The method of claim 1, wherein the solver comprises a simulated annealing method.

16. The method of claim 1, wherein the quantum computing resource comprises at least one of a quantum simulator, a quantum computing system, or a hybrid computer system.

17. A computer system comprising:
a quantum computing resource; and
a classical computing resource comprising:
one or more classical processing units; and
memory storing instructions that, when executed by the one or more classical processing units, cause the one or more classical processing units to:
obtain an initial optimization problem;
precondition the initial optimization problem, comprising:
causing the quantum computing resources to execute a quantum-based algorithm corresponding to the initial optimization problem;
obtaining quantum results based the execution of the quantum-based algorithm, the quantum results being indicative of one or more solutions to the initial optimization problem as determined by the quantum-based algorithm; and
based on the quantum results generating a preconditioned optimization problem comprising elements indicative of correlations between variables associated with the initial optimization problem;
obtain preconditioned problem results based on an execution of a solver on the preconditioned optimization problem; and
return the preconditioned problem results as the output of the initial optimization problem.

18. The computer system of claim 17, wherein the solver comprises a semidefinite programing method.

19. The computer system of claim 18, wherein the semidefinite programming method comprises a relax-and-round algorithm, generating the preconditioned optimization problem comprises constructing a matrix, and executing the solver on the preconditioned optimization problem comprises performing the relax-and-round algorithm on the matrix.

20. The computer system of claim 17, wherein the solver comprises the quantum-based algorithm, and executing the solver on the preconditioned optimization problem comprises causing the quantum computing resource to execute the quantum-based algorithm.

21-32. (canceled)
